(19) United States
(12) Patent Application Publication
(10) Pub. No.: US 2015/0220699 A1
(43) Pub. Date: Aug. 6, 2015

(54) COMPUTERIZED SYSTEM AND METHOD FOR DETERMINING HOSPITAL ADMISSION RISK

(71) Applicants: Andrey Ostrovsky, Brookline, MA (US); Jeffrey Levy, San Francisco, CA (US)

(72) Inventors: Andrey Ostrovsky, Brookline, MA (US); Jeffrey Levy, San Francisco, CA (US)

(21) Appl. No.: 14/612,215

(22) Filed: Feb. 2, 2015

Related U.S. Application Data
(60) Provisional application No. 61/936,450, filed on Feb. 6, 2014.

(51) Int. Cl. G06F 19/00; G06Q 50/22

(52) U.S. Cl. CPC G06F 19/3431; G06Q 50/22

(57) ABSTRACT

A computing device may compute the hospital admission risk of a patient as of a first risk calculation date after provision of one or more interventions for the patient. Each such intervention may be of a type that can readily be provided without bringing the patient to a hospital. According to one method, an input device may be used to receive first user input indicative of a first intervention performed for the patient. From a data store, a first risk factor corresponding to the first intervention, and a first time period over which the first risk factor is applicable, may be retrieved. At a processor, a first intervention date may be compared with the first risk calculation date to determine that the first risk calculation date is within the first time period. The first risk factor may be used to compute and display the hospital admission risk for the patient.

### CROSS-REFERENCE TO RELATED APPLICATION

The present application claims priority from U.S. Provisional Application Ser. No. 61/936,450 for “Health Care Coordination Platform,” Attorney Docket No. CAH001-PROV, filed Feb. 6, 2014, which is incorporated by reference herein in its entirety.

### TECHNICAL FIELD

The present document relates to health care data tracking and utilization, and more specifically, to computer-driven systems and methods for estimating hospital admission risk for patients.

### DESCRIPTION OF THE RELATED ART

Many people experience conditions that require hospital treatment. In many cases, the condition that necessitated the hospital visit is ongoing and requires further observation and/or treatment. Hence many people, particularly the elderly, have some type of long-term care in place, outside the hospital environment. Community health workers often have the most intimate contact with patients who are at risk of hospital admission. Many computerized tracking systems exist to assist in the provision of health care services.

Unfortunately, known computing systems generally lack tools such community health workers can use to readily assess the risk levels of the people they serve. Such care workers often lack the diagnostic tools and procedures that would be present in a doctor's office or hospital. Thus, in spite of their frequent contact with patients, the computing systems they use often lack the tools to help them to know which patients are at higher risk for hospital admission, and therefore require different treatments, more frequent visits, and/or the involvement of a physician. Further, such computing systems often lack the ability to effectively and efficiently receive patient data and/or requests for summary data, and further lack the ability to display the resulting information in a manner that facilitates proper care for the patient.

### SUMMARY

Various embodiments of the present disclosure provide computerized systems and methods whereby a user, such as a care provider, can obtain an estimate of the hospital admission risk of a patient. The care provider need not necessarily be a physician or a trained nurse, and need not have access to the diagnostic equipment or procedures of a doctor's office or hospital. Rather, the present disclosure provides computerized systems and methods by which such a care provider can obtain an estimate of hospital admission risk based on observations conducted in the ordinary course of his or her care for the patient. A computing device such as a smartphone may be used to calculate the admission risk.

More specifically, the hospital admission risk of the patient may be evaluated by the computing device as of a risk calculation date after the provision of one or more interventions for the patient. Each time an intervention is provided, the care provider may provide a record of the care via an input device of the computing device. Each such intervention may be of a type that can readily be provided without bringing the patient to a hospital.

The computing device may have or may be connected to a data store with a database containing risk factors and/or applicable time periods for each of various intervention types. From the data store, the risk factor and applicable time period for each intervention may be retrieved. The intervention date for each intervention may be compared with the risk calculation date to determine whether the risk factor for that intervention is applicable to the risk calculation date.

Then, the risk factors for all interventions applicable to the risk calculation date may be combined in various ways by the computing device to estimate the hospital admission risk for the patient. Each risk factor may be a risk score expressed in numerical form; the hospital admission risk may be obtained by computing a log transformation of the risk scores for each applicable intervention. If desired, a change factor may also be added by the computing device to help take into account recent trending in the interventions provided to the patient.

Further details and variations are described herein.

### BRIEF DESCRIPTION OF THE DRAWINGS

The accompanying drawings, together with the description, illustrate several embodiments. One skilled in the art will recognize that the particular embodiments illustrated in the drawings are merely exemplary, and are not intended to limit scope.

FIG. 1A is a block diagram depicting a hardware architecture according to one embodiment.

FIG. 1B is a block diagram depicting a hardware architecture in a client/server environment, according to one embodiment.

FIGS. 2A to 2B are block diagrams depicting data structures that maybe used in conjunction with the intervention reports and intervention score data of FIGS. 1A and 1B, respectively.

FIG. 3 is a block diagram depicting a system for automated hospital admission risk determination, according to one embodiment.

FIG. 4 is a flowchart depicting a method hospital admission risk assessment, according to one embodiment.

FIG. 5 is a screenshot depicting the user interface of a software program that may be used to carry out the method of FIG. 4, according to one embodiment.

FIG. 6 is a screenshot depicting the user interface with a pointer poised to select a new risk calculation date.

FIG. 7 is a screenshot depicting the user interface after the user has selected the new risk calculation date.

FIG. 8 is a chart illustrating exemplary intervention score data structures.

FIG. 9 is a screenshot depicting the user interface after the user has selected the patient assessment.

### DETAILED DESCRIPTION OF THE EMBODIMENTS

In at least one embodiment, the system and method described herein facilitate the computerized estimation of hospital admission risk for a patient based on interventions provided to the patient by a care provider. The interventions may be recorded as intervention records through the use of a computing device used by the care provider. The intervention records may be used to generate the estimated hospital admission risk, as will be described in greater detail below.

In this application, a “care provider” is any individual or entity that provides services designed to promote the health and/or well-being of an individual. A “care provider” need not have any specific credentials or job responsibilities. By contrast, a “primary care provider” is a physician, nurse, or medical office who provides health care services to the patient. A “patient” is an individual receiving care from a caregiver. A patient need not have any particular hospitalization history or health condition.

An “intervention” is one or more actions taken by the care provider to remediate a condition of the patient. An intervention need not involve any medical treatment; rather, counseling and/or routine treatments may be interventions if necessitated by the condition of the patient. A “risk factor” is an indication of the degree of concern attached to a particular intervention and/or condition. An “applicable time period” is a time period over which a risk factor is deemed to be applicable for purpose of admission risk estimation.

“Admission risk” is the likelihood that a patient will experience a condition that requires an intervention that can only be performed in a medical facility such as a hospital or doctor's office. “Hospital admission risk” is the likelihood that a patient will experience a condition that requires an intervention that can only be performed in a hospital. This may be the first time the patient is admitted to the hospital, or any subsequent admission (“readmission”). A “risk calculation date” is a date for which admission risk is to be estimated (representing the risk of admission to a medical facility for the patient as of the risk calculation date).

### System Architecture

According to various embodiments, the system can be implemented on any electronic device equipped to receive, store, and present information. Such an electronic device may be, for example, a desktop computer, laptop computer, smartphone, tablet computer, or the like.

Although the system is described herein in connection with an implementation in a computer, one skilled in the art will recognize that the techniques described herein can be implemented in other contexts, and indeed in any suitable device capable of receiving and/or processing user input. Accordingly, the following description is intended to illustrate various embodiments by way of example, rather than to limit scope.

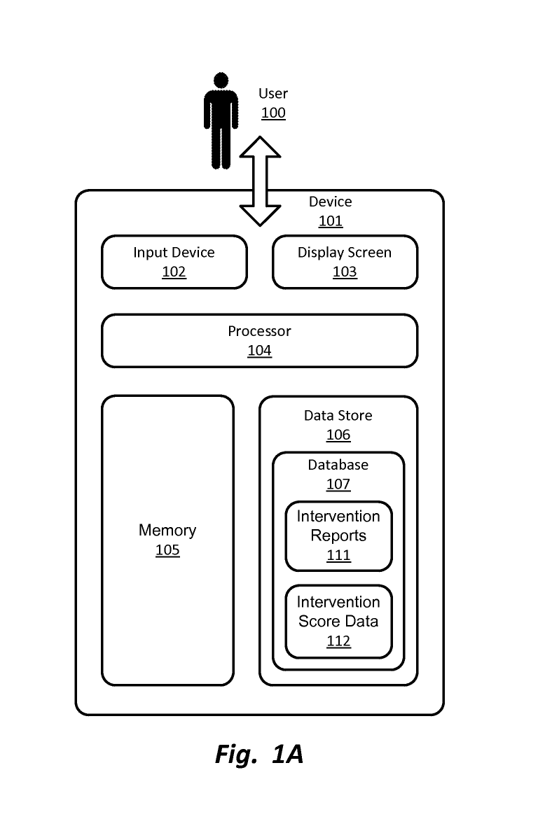

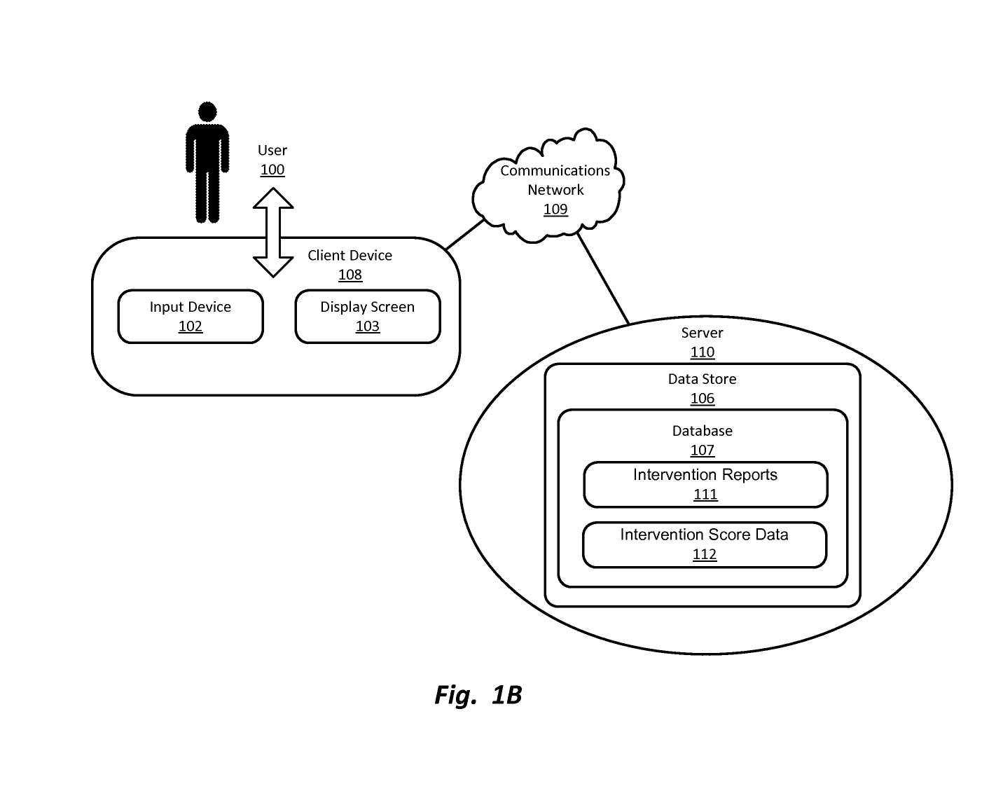

Referring now to FIG. 1A, there is shown a block diagram depicting a hardware architecture for practicing the described system, according to one embodiment. Such an architecture can be used, for example, for implementing the techniques of the system in a computer or other device 101. Device 101 may be any electronic device equipped to receive, store, and/or present information, and to receive user input in connect with such information.

In at least one embodiment, device 101 has a number of hardware components well known to those skilled in the art. Input device 102 can be any element that receives input from user 100, including, for example, a keyboard, mouse, stylus, touch-sensitive screen (touchscreen), touchpad, trackball, accelerometer, five-way switch, microphone, or the like. Input can be provided via any suitable mode, including for example, one or more of: pointing, tapping, typing, dragging, and/or speech.

Data store 106 can be any magnetic, optical, or electronic storage device for data in digital form; examples include flash memory, magnetic hard drive, CD-ROM, DVD-ROM, or the like. In at least one embodiment, data store 106 stores information which may include one or more databases, referred to collectively as a database 107, that can be utilized and/or displayed according to the techniques described below. In another embodiment, database 107 can be stored elsewhere, and retrieved by device 101 when needed for presentation to user 100. Database 107 may include one or more data sets, which may be used for a variety of purposes and may include a wide variety of files, metadata, and/or other data. In at least one embodiment, database 107 may include intervention reports 111 and intervention score data 112.

Display screen 103 can be any element that graphically displays information such as items from database 107 and/or the results of steps performed on such items to provide information useful to a user. Such output may include, for example, raw data, data visualizations, navigational elements, queries requesting confirmation and/or parameters for information identification, display, or presentation, or the like. In at least one embodiment where only some of the desired output is presented at a time, a dynamic control, such as a scrolling mechanism, may be available via input device 102 to change which information is currently displayed, and/or to alter the manner in which the information is displayed.

Processor 104 can be a conventional microprocessor for performing operations on data under the direction of software, according to well-known techniques. Memory 105 can be random-access memory, having a structure and architecture as are known in the art, for use by processor 104 in the course of running software.

Data store 106 can be local or remote with respect to the other components of device 101. In at least one embodiment, device 101 is configured to retrieve data from a remote data storage device when needed. Such communication between device 101 and other components can take place wirelessly, by Ethernet connection, via a computing network such as the Internet, via a cellular network, or by any other appropriate means. This communication with other electronic devices is provided as an example and is not necessary.

In at least one embodiment, data store 106 is detachable in the form of a CD-ROM, DVD, flash drive, USB hard drive, or the like. Database 107 can be entered from a source outside of device 101 into a data store 106 that is detachable, and later displayed after the data store 106 is connected to device 101. In another embodiment, data store 106 is fixed within device 101.

Referring now to FIG. 1B, there is shown a block diagram depicting a hardware architecture in a client/server environment, according to one embodiment. Such an implementation may use a “black box” approach, whereby data storage and processing are done completely independently from user input/output. An example of such a client/server environment is a web-based implementation, wherein client device 108 runs a browser that provides a user interface for interacting with web pages and/or other web-based resources from server 110. Items from the database 107, reports, and/or other data derived from the database 107 can be presented as part of such web pages and/or other web-based resources, using known protocols and languages such as Hypertext Markup Language (HTML), Java, JavaScript, and the like.

Client device 108 can be any electronic device incorporating the input device 102 and/or display screen 103, such as a desktop computer, laptop computer, personal digital assistant (PDA), cellular telephone, smartphone, music player, handheld computer, tablet computer, kiosk, game system, or the like. Any suitable type of communications network 109, such as the Internet, can be used as the mechanism for transmitting data between client device 108 and server 110, according to any suitable protocols and techniques. In addition to the Internet, other examples include cellular telephone networks, EDGE, 3G, 4G, long term evolution (LTE), Session Initiation Protocol (SIP), Short Message Peer-to-Peer protocol (SMPP), SS7, Wi-Fi, Bluetooth, ZigBee, Hypertext Transfer Protocol (HTTP), Secure Hypertext Transfer Protocol (SHTTP), Transmission Control Protocol/Internet Protocol (TCP/IP), and/or the like, and/or any combination thereof. In at least one embodiment, client device 108 transmits requests for data via communications network 109, and receives responses from server 110 containing the requested data.

In this implementation, server 110 is responsible for data storage and processing, and incorporates data store 106 for storing database 107. Server 110 may include additional components as needed for retrieving data and/or database 107 from data store 106 in response to requests from client device 108.

In at least one embodiment, data store 106 may be organized into one or more well-ordered data sets, with one or more data entries in each set. Data store 106, however, can have any suitable structure. Accordingly, the particular organization of data store 106 need not resemble the form in which information from data store 106 is displayed to user 100. In at least one embodiment, an identifying label is also stored along with each data entry, to be displayed along with each data entry.

In at least one embodiment, database 107 is organized in a file system within data store 106. Appropriate indexing can be provided to associate particular documents with particular quantitative data elements, reports, other documents, and/or the like. Database 107 may include any of a wide variety of data structures known in the database arts. As in FIG. 1A, database 107 may include one or more data sets, which may include intervention reports 111, intervention score data 112, and/or other data (not shown).

Intervention reports 111 and/or intervention score data 112 can be retrieved from the data store 106, or from any other source. Data store 106 may be client-based and/or server-based. In at least one embodiment, input device 102 is configured to receive data entries from user 100, to be added to data store 106. User 100 may provide such data entries via the hardware and software components described above according to means that are well known to those skilled in the art. Server 110 may be connected to several client devices 108 that are used by various individuals of the enterprise, and may thus store intervention reports 111 and/or intervention score data 112 from multiple users and/or multiple client devices 108. Intervention reports 111 and/or intervention score data 112 may be used to generate notifications to the user 100, which may be transmitted via the display screen 103 and/or one or more other output devices.

Display screen 103 can be any element that graphically displays information such as items from database 107 and/or the results of steps performed on such items to provide information useful to a user. Such output may include, for example, raw data, data visualizations, navigational elements, queries requesting confirmation and/or parameters for information identification, display, or presentation, or the like. In at least one embodiment where only some of the desired output is presented at a time, a dynamic control, such as a scrolling mechanism, may be available via input device 102 to change which information is currently displayed, and/or to alter the manner in which the information is displayed.

Processor 104 can be a conventional microprocessor for use in an electronic device to perform operations on data under the direction of software, according to well-known techniques. Memory 105 can be random-access memory, having a structure and architecture as are known in the art, for use by processor 104 in the course of running software.

In one embodiment, the system can be implemented as software written in any suitable computer programming language, whether in a standalone or client/server architecture. Alternatively, it may be implemented and/or embedded in hardware.

### Data Structures

In general, the data stored within data store 106 of FIG. 1A or FIG. 1B may include one or more pieces of data, each of which may be of any desired length and format. Thus, each piece of data may be a character string, integer, floating point number, or any other type of data, and may thus represent any information such as names, times, dates, currency amounts, percentages, fractions, physical dimensions, or any other data that may desirably be stored in a computer. As mentioned previously, data store 106 may include intervention reports 111, intervention score data 112, and/or other data (not shown).

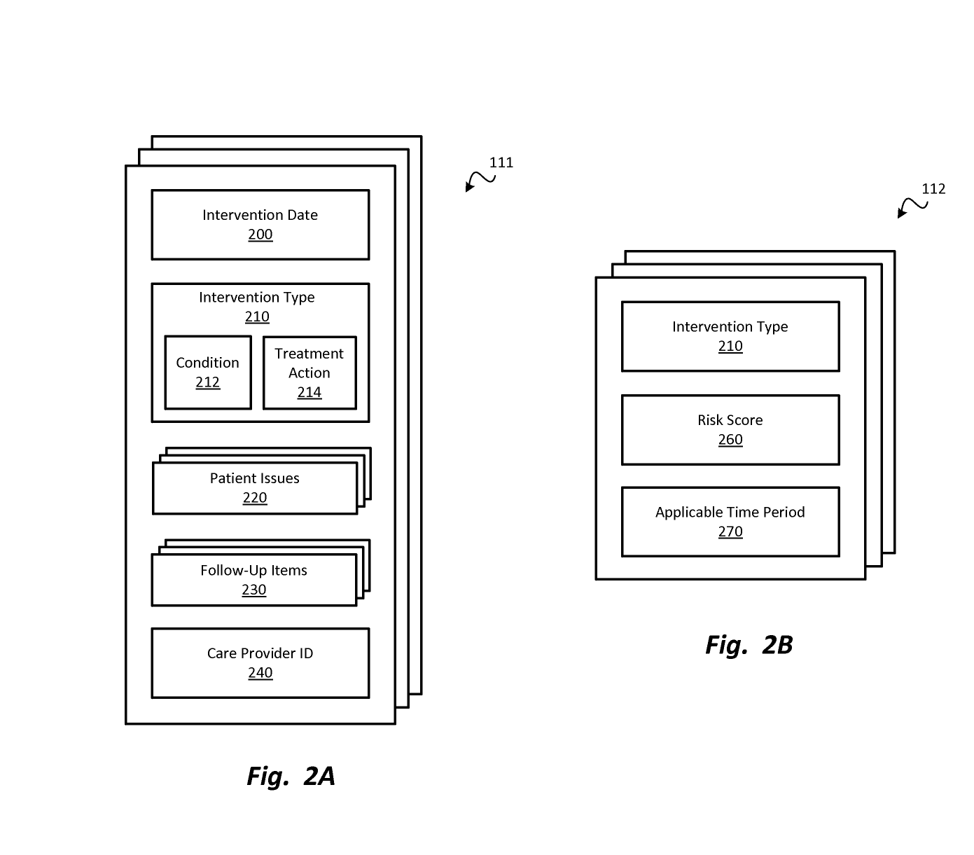

Referring to FIG. 2A, a block diagram illustrates the intervention reports 111 in greater detail. As shown, the intervention reports 111 may include various records; in some embodiments, each intervention (i.e., each action taken by a care provider to remediate a condition of the patient) has its own record.

Each record may include, but need not be limited to, the information illustrated in FIG. 2A. More specifically, each record of the intervention reports 111 may include an intervention date 200, an intervention type 210, one or more patient issues 220, one or more follow-up items 230, and a care provider ID 240.

The intervention date 200 may be the date on which the intervention was carried out. In the event that the intervention extends across multiple days, the intervention date 200 may be the date on which the intervention commences. In the event that the intervention does not commence on the same date the care provider determines that it is needed, the intervention date 200 may be the date on which the care provider determines that the intervention is needed.

In alternative embodiments, the intervention date 200 may be modified, for example, to be the date an intervention is completed. Further, in other alternative embodiments, a rule-based system may be used to determine the intervention date 200 that is most appropriate based on other data regarding the intervention, such as the intervention type 210.

For example, for a patient that is prescribed a certain medication, the intervention date 200 may be the date on which the prescription is issued. For a patient that is prescribed a different type of medication, the intervention date 200 may be the date on which he or she begins taking the medication. For a patient that is prescribed yet another different type of medication, the intervention date 200 may be the date on which he or she finishes taking the medication. Those of skill in the art will recognize that the intervention date 200 may be determined in a variety of ways. The manner in which risk factors and/or applicable time periods for an intervention occurs may be dependent upon the intervention date 200 used.

The intervention type 210 may be indicative of nature of the patient's problem. The intervention type 210 may optionally be used as a reference to classify a particular type of patient situation. The classification may be based on any of a variety of identifying characteristics, such as a condition 212 of the patient that precipitate the intervention and/or the treatment action 214 taken by the care provider as part of the intervention. For example, if a patient is hospitalized following a cardiac arrest, the condition 212 may be the cardiac arrest, while the treatment action 214 may be the hospitalization. Either may be used to classify associated risk scores and time periods; thus, the intervention type 210 may be “cardiac arrest” and/or “hospitalization.” Either identifier can provide a useful tool for categorizing admission risk.

The patient issues 220 may include any conditions of the patient. If desired, the patient issues 220 may be limited to issues that relate to the intervention type (i.e., that relate to the condition 212 and/or the treatment action 214). For example, if the patient had been having chest pains, this may be listed as a patient issue 220 in the intervention record described previously for a patient who was hospitalized following a cardiac arrest.

The follow-up items 230 may be future actions that need to be taken relative to the patient. For example, medications to be taken, periodic checkups, treatments to be carried out in the future, or the like may be included in the follow-up items 230. If desired, the follow-up items 230 may also be limited to actions that relate to the intervention type. For example, for the cardiac arrest situation mentioned previously, the follow-up items 230 may include periodic status checks on the status of the patient's heart, the performance of heart surgery, and/or the like.

The care provider ID 240 may be the identity of the care provider who performed the intervention. The care provider ID 240 may optionally include additional information that may be helpful to another person reviewing the record for the intervention. Thus, the care provider ID 240 may include the name, contact information, license information, prior work experience, other patient names, health specialty, and/or other information for the care provider who performed the intervention.

Referring to FIG. 2B, a block diagram illustrates the intervention score data 112 in greater detail. As shown, the intervention score data 112 may include various records; in some embodiments, each intervention type 210 (i.e., each action taken by a care provider to remediate a condition of the patient) has its own record in the intervention score data 112.

Each record may include, but need not be limited to, the information illustrated in FIG. 2B. More specifically, each record of the intervention score data 112 may include the intervention type 210, a risk factor in the form of a risk score 260 or the like, and/or an applicable time period 270.

The intervention type 210 may be the same as that of FIG. 2A. Thus, the intervention type 210 of the intervention score data 112 may include the condition 212 that precipitated the intervention and/or the treatment action 214 taken by the care provider. There may optionally be a separate record in the intervention score data 112 for each intervention type 210. Thus, each type of intervention may have its own risk score 260 and/or applicable time period 270.

The risk score 260 may be a risk factor designed to provide a numerical indication of the likelihood of hospital admission following an intervention of the intervention type 210 with which it shares a record in the intervention score data 112. For example, the risk score 260 may be a number of points, with a larger number of points representing a greater hospital admission risk. In alternative embodiments, risk factors may be provided in other forms, such as letters or numbers, in place of the risk score 260. However, the risk score 260 may facilitate “stacking,” or the combination of risk factors from multiple interventions to provide an assessment of hospital admission risk arising from all patient conditions.

The risk score 260 may generally be expected to be proportional to the gravity of the intervention type 210; an intervention type 210 of “cardiac arrest” may be expected to have a much higher risk score 260 than an intervention type 210 of “ingrown toenail.” However, the severity of the condition 212 that precipitated an intervention may not necessarily be proportional to hospital admission risk; for example, a patient that has been successfully treated for appendicitis via removal of his or her appendix may not be at a high risk for hospital admission, despite the life-threatening potential of appendicitis.

In some embodiments, the risk score 260 for each intervention type 210 may be determined statistically. For example, actual hospital admission rates of patients with each intervention type 210 may be tracked over time to generate the risk scores 260.

In some embodiments, the risk score 260 may be dependent on other factors than just the intervention type 210. In some embodiments, information such as prior hospitalizations, prior occurrences of the same intervention type 210, and/or vital statistics (such as age, weight, height, gender, blood pressure, and/or the like) may be used to adjust the risk score 260 for an intervention of an intervention type 210. Additionally or alternatively, such factors may be taken into account in the determination of the intervention type 210. The intervention types may then be granular enough to accommodate more detailed information. For example, two different intervention types 210 may exist for “cardiac arrest” and “cardiac arrest after prior hospitalization for cardiac arrest.”

Notwithstanding the foregoing, in some embodiments, it may be advantageous to obtain the risk score 260 based solely off of data that can be obtained without access to medical office and/or hospital facilities. The care providers who most frequently provide the intervention reports 111 may not be doctors or nurses, but rather home care providers, nursing home employees, and/or other individuals with limited training and/or limited equipment. Thus, it may be advantageous to be able to provide the risk scores 260 with a relatively high degree of accuracy with the need for such information.

The applicable time period 270 may be the time period over which the patient is considered to be at increased risk of hospital admission due to the occurrence of an intervention of the intervention type 210. Thus, for an intervention type 210, the risk score 260 may be applicable over the applicable time period 270.

The applicable time period 270 may begin to run as of the date of the intervention (for example, as of the intervention date 200 of the intervention reports 111). After the expiration of the applicable time period 270, the patient may be deemed to have passed beyond the period of added risk corresponding to the intervention. Thus, the risk score 260 may not be factored into the assessment of hospital admission risk for risk calculation dates occurring after the applicable time period 270 has ended.

The applicable time period 270 may vary based on the intervention type 210. Generally, an intervention for a condition 212 of greater severity may have a longer applicable time period 270, because more serious conditions may yield longer periods of increased hospital admission risk. However, as in the case of the risk score 260, proportionality cannot simply be assumed; some severe conditions 212 may have risk factors of very short duration, while less serious conditions 212 need to be accounted for on a longer-term basis. As with the risk scores 260, statistical analysis of actual interventions and hospital admissions may advantageously be used to obtain the applicable time period 270 for each intervention type 210.

In one embodiment, the risk score 260, in its entirety, may be used throughout the applicable time period 270 as a contributor to hospital admission risk. Once the applicable time period 270 is over, the risk score 260 may not be applied in the calculation of hospital admission risk. In the alternative, any of various algorithms may be used to reduce the risk score 260 (or reduce application of the risk score 260) gradually through the duration of the applicable time period 270 to represent a gradually diminishing hospital admission risk arising from the occurrence of an intervention. Such a reduction may follow any mathematical model, including but not limited to linear reductions, polynomial reductions, logarithmic reductions, and/or the like.

In yet other alternative embodiments, application of the risk score 260 may follow a more complex pattern. For example, for a patient with a condition 212 of pregnancy and a treatment action 214 of a doctor's visit for a three-month checkup, the hospital admission risk may rise substantially six months after the intervention to represent the likelihood of hospitalization incident to childbirth. Thus, the applicable time period 270 may simply a number of days, or may have a more complex pattern that is determined via a mathematical formula, a lookup table, and/or the like.

### Automated Hospital Admission Risk Assessment

Hospital admission risk may be determined in a variety of ways. According to some embodiments, hospital admission risk may be provided as part of a software platform used by care providers. The software platform may serve multiple purposes, such as tracking patient conditions, scheduling visits, communications among care providers, obtaining information regarding recommended interventions, writing or filling prescriptions, and/or the like. Thus, assessment of hospital admission risk may be carried out in conjunction with other activities that can be performed on the software platform. Alternatively, assessment of hospital admission risk may be carried out through the use of more specialized software that only provides the admission risk assessment functionality. In either case, the methods set forth herein may be performed with the aid of a computing system, such as the device 101 of FIG. 1A and/or the client device 108 and/or server 110 of FIG. 1B.

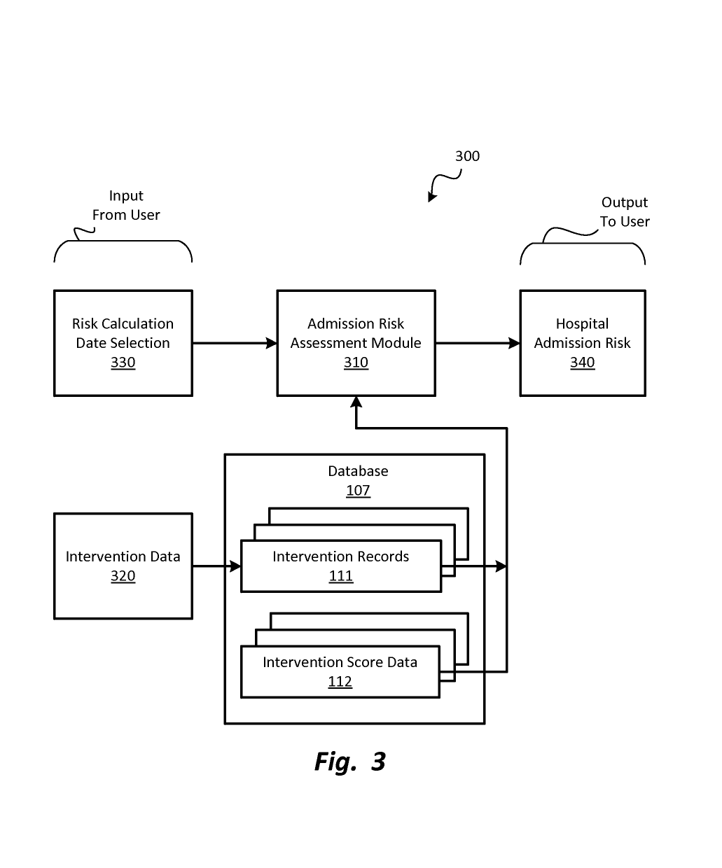

Referring to FIG. 3, a block diagram illustrates a system 300 according to one embodiment. The system 300 may be designed to facilitate patient care by providing hospital admission risk estimates based on the intervention reports 111 and the intervention score data 112 in the database 107. As indicated previously, hospital admission risk assessment functionality may be carried out in a system that performs other functions pertinent to patient care. However, only the architecture pertinent to hospital admission risk assessment is shown in FIG. 3. Thus, the system 300 may have a admission risk assessment module 310, as shown.

One or more users 100 may provide a variety of inputs to the system 300, for example, via the input device 102 of the computing device 101 and/or the client device 108. For example, one or more users 100 may provide intervention data 320 based on observations made in the course of servicing the patient. The intervention data 320 may be stored in the intervention reports 111, as shown in FIG. 2A. If desired, an intervention report 111 may be kept for each visit to the patient, regardless of whether any action was carried out by the care provider.

Advantageously, the intervention data 320 may be gathered from multiple care providers, and may be stored in the database 107 to provide a relatively complete picture of the patient's care history. The client/server architecture shown in FIG. 1B may be used to facilitate aggregation of the intervention report 111 from multiple care providers.

Notably, some of the intervention data 320 may be gathered and/or stored automatically; for example, if the care provider uses a portable, GPS-enabled computing device, which may be the computing device 101 of FIG. 1A or the client device 108 of FIG. 1B, visits to the patient by the care provider may automatically be tracked and/or date stamped by the system 300 through the use of the location data from the computing device. If the care provider uses any electronic testing equipment, such equipment may optionally be designed to transmit results directly to the system 300.

When a user 100 is to receive the estimated admission risk for the patient, he or she may provide, as input to the system 300, a risk calculation date selection 330 in which he or she designates the risk calculation date. This selection may be explicit, or may be done automatically, for example, by assuming that the user 100 wishes to receive estimated admission risk as of the current date, unless the user 100 selects a different date.

Notably, if desired, the risk calculation date selection 330 may include multiple selected dates. For example, the user 100 may select to obtain estimated admission risk for each of the next thirty days. He or she may then use this information to plan visits to the patient over the thirty-day period, for example, by scheduling more frequent visits and/or more thorough observation on the days when the estimated admission risk for the patient is the highest. Although the following description will generally assume that only a single risk calculation date has been selected, the method for assessing the risk calculation on a single risk calculation date may be repeated for other dates to provide hospital admission risk for multiple risk calculation dates.

Once the system 300 has received the risk calculation date selection 330, the admission risk assessment module 310 may assess the hospital admission risk 340 for the patient on the risk calculation date. This may commence by retrieving the intervention reports 111 for the patient, or at least retrieving the subset of the intervention reports 111 that may be relevant to assessment of the admission risk. In some examples, intervention reports 111 with intervention dates 200 that are earlier than a certain date (for example, intervention dates 200 that precede the risk calculation date by more than the largest applicable time period 270 for any of the intervention types 210) may not be retrieved because they will not affect the calculation of the hospital admission risk 340.

Further, intervention score data 112 may also be retrieved from the database 107. In some embodiments, only a subset of the intervention score data 112 may be retrieved. More particularly, only the intervention score data 112 that pertain to the intervention types 210 found in the intervention reports 111 retrieved for the patient may be retrieved. Intervention score data 112 pertaining to intervention types 210 that the patient has not received recently enough to affect calculation of the hospital admission risk 340 may not be retrieved.

Once the intervention score data 112 has been retrieved, the admission risk assessment module 310 may calculate the hospital admission risk 340. The admission risk assessment module 310 may first determine which of the intervention reports 111 fall within the appropriate time period for relevance to assessment of the hospital admission risk 340. This may be done by comparing the intervention date 200 of each intervention report 111 with the risk calculation date, and based on the results of the comparison, determining whether the risk calculation date is within the applicable time period 270 that applies to the intervention type 210 for the intervention report 111.

For example, if comparison of the intervention date 200 for an intervention report 111 reveals that the intervention occurred forty-five days prior to the risk calculation date, but the applicable time period 270 for the intervention type 210 of the intervention report 111 is only thirty days, the admission risk assessment module 310 may determine that the risk score 260 for that particular intervention will not be factored into the calculation of the hospital admission risk 340. Conversely, if the applicable time period 270 for the intervention type 210 of the intervention report 111 is greater than the difference between the intervention date 200 and the risk calculation date, the admission risk assessment module 310 may include the risk score 260 for the intervention report 111 in the calculation of the hospital admission risk 340.

Next, the risk scores 260 for all intervention reports 111 that fall within the corresponding applicable time period 270 may be combined to yield the hospital admission risk 340. This combination may be made in any of a variety of ways. According to some embodiments, combining the risk scores 260 may be a simple summation, in which the risk score 260 for all interventions (i.e., for all intervention reports 111) that are applicable on the risk calculation date may be added together.

In alternative embodiments, other mathematical combinations may be used. In some embodiments, weighted summations may be used. For example, some interventions may be deemed to have a greater effect on hospital admission risk than others; thus, each record of the intervention score data 112 may also have a weight associated with the intervention type 210 for that record. In other alternative embodiments, a log transformation or other mathematical combination of the risk scores 260 for the applicable interventions may be used.

In some embodiments, the combination of risk scores 260 may be supplemented with a change factor designed to adjust the hospital admission risk 340 for trending in the intervention data 320 for the patient. For example, a patient who has experienced a buildup of interventions in his or her recent past may have an actual hospital admission risk that is higher than would be indicated by the sum of risk scores 260 for his or her interventions. This change factor may be termed a “something brewing” variable to account for the possibility that the patient is experiencing a condition 212 that has not yet been diagnosed or acted upon, and may therefore be at increased risk of hospital admission.

Such a change factor may be calculated in a wide variety of ways. In some embodiments, the change factor may be calculated by comparing risk scores applicable to all interventions for the patient within a recent time period, with an average of risk scores applicable to all interventions for the patient over a reference time period. Additionally or alternatively, the change factor may be calculated by adding risk scores applicable to all interventions provided during a single care episode for the patient. In either case, a large increase in the risk scores of recent and/or single-episode interventions may result in a high change factor, which may be used to boost the hospital admission risk 340 to account for the “something brewing variable.”

Once the hospital admission risk 340 has been computed, it may be provided to the user 100. This may be done, for example, via the display screen 103 of the computing device 101 and/or the client device 108. The hospital admission risk 340 may be provided in textual and/or graphical form for easy comprehension, as will be discussed in the examples.

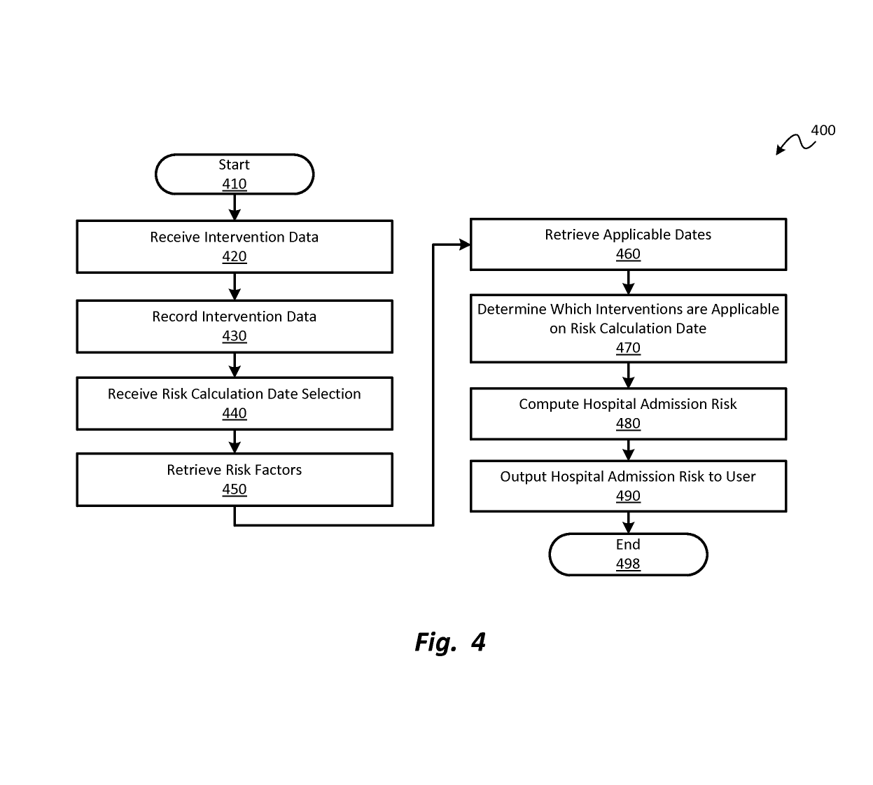

Referring to FIG. 4, a flowchart diagram illustrates a method 400 of assessing hospital admission risk according to one embodiment. The method 400 may be carried out through the use of a system such as the system 300 of FIG. 3, as will be described by way of example below. Any suitable hardware implementation can be used, such as for example the architectures depicted in FIGS. 1A and 1B. Additionally or alternatively, other systems may be used to carry out the method 400. Further, a system such as the system 300 of FIG. 3 may be used to carry out other methods besides the method 400 of FIG. 4.

As shown, the method 400 may start 410 with a step 420 in which intervention data 320 is received from one or more users 100. As mentioned previously, this may be done by one or more care providers in the course of providing care to the patient. In a step 430, the intervention data 320 may be recorded in the intervention reports 111 of the database 107.

In a step 440, the risk calculation date selection 330 may be received from the user 100. As mentioned before, this selection may be explicit or implicit, and may include one or more risk calculation dates.

In a step 450, the risk score 260 for each intervention may be retrieved for each intervention. In a step 460, the applicable time period 270 for each intervention may be retrieved for each intervention. The appropriate risk score 260 and applicable time period 270 may be determined by matching the intervention type 210 of each intervention report 111 with the same intervention type 210 of the intervention score data 112.

Once the risk scores 260 and the applicable time periods 270 have been retrieved, the system 300 may determine, in a step 470, which interventions are applicable on the risk calculation date. As described previously, this may be accomplished by taking the difference between the intervention date 200 for each intervention with the risk calculation date, and then comparing that difference with the applicable time period 270 for that intervention. This may determine which interventions are factored into the calculation of the hospital admission risk 340.

Once the interventions that should impact the hospital admission risk 340 have been identified, the system 300 may, in a step 480, compute the hospital admission risk 340 as of the risk calculation date. The system 300 may, in a step 490, output the hospital admission risk 340 to the user 100. The method 400 may then end 498. In alternative embodiments, the system 300 may prompt the user 100 to select a new risk calculation date, select a graphical visualization for hospital admission risk, schedule treatment or follow-up visits to the patient, and/or perform other activities.

### Examples

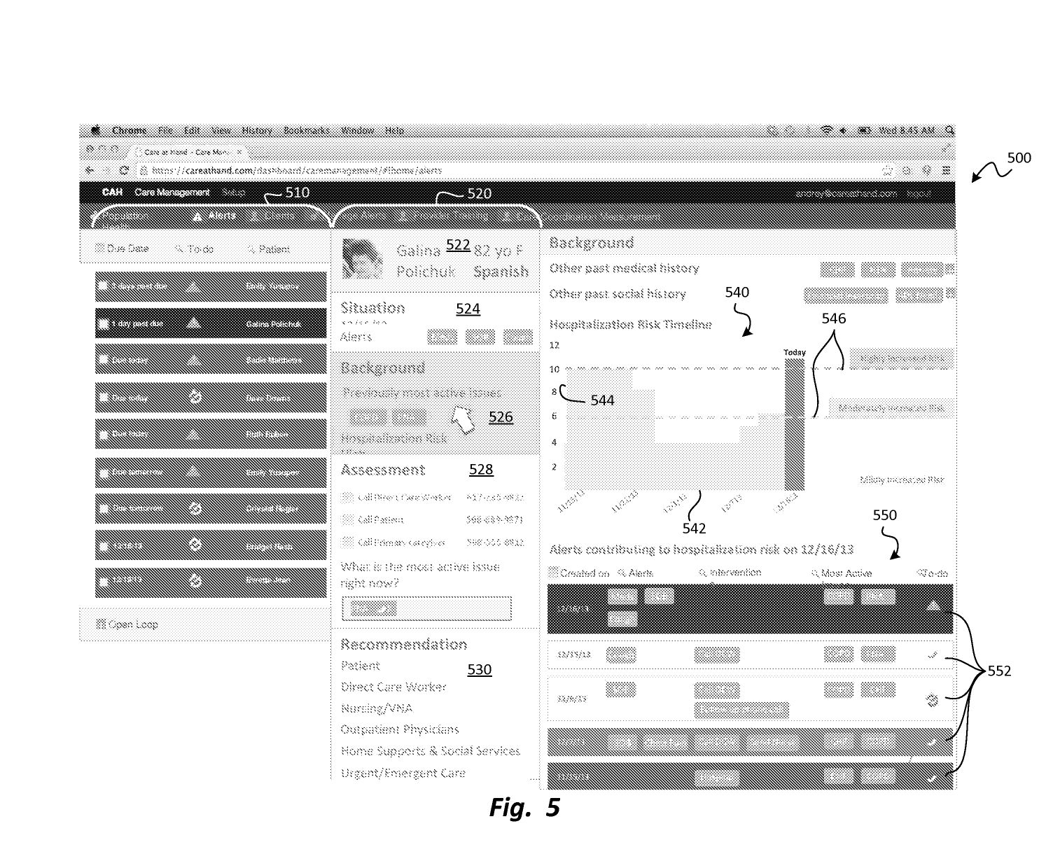

Referring to FIG. 5, a screenshot 500 illustrates the user interface of a software program that may be used to carry out the method 400 of the present disclosure. The software program may have a login for each care provider, and may thus provide information and/or functionality specific to that care provider. The screenshot 500 may have a task column 510 with information on tasks the care provider needs to perform, and a patient column 520 with data regarding a specific patient under the care of the care provider. The screenshot 500 is an example of output that may be presented on any suitable output device, such as for example display screen 103 of FIG. 1A or FIG. 1B. In addition, in various embodiments, a user can interact with elements of such output via any suitable input device, such as input device 102 of FIG. 1A or FIG. 1B. One type of interaction is touching, pointing at, and/or selecting on-screen elements such as links, buttons, and/or the like, or maneuvering a pointing device to cause an on-screen cursor to move and/or activate such on-screen elements; keyboard controls are also possible.

The patient column 520 may provide various data and/or functionality pertaining to the patient, including but not limited to patient identification information 522, a patient situation 524, patient background 526, patient assessment 528, and/or patient recommendation 530. The patient identification information 522, the patient situation 524, and the patient background 526 may be primarily informational. The patient assessment 528 and the patient recommendation 530 may provide functionality whereby the care provider may communicate with other care providers, such as the patient's primary care provider, make recommendations for further actions regarding the patient, and/or the like.

Selecting the patient background 526 may reveal additional information about the patient's background. This additional information may include a hospitalization risk timeline 540 and an intervention summary 550 of interventions and/or alerts that contribute to the risk shown in the hospitalization risk timeline 540.

The hospitalization risk timeline 540 may have a horizontal axis 542 showing dates over a time period, such as a one-month time period. The dates on the horizontal axis 542 may, by default, terminate in the current date (at the right-hand end). The hospitalization risk timeline 540 may also have a vertical axis 544, which may indicate the hospital admission risk on each date on the horizontal axis 542. Thus, the user 100 may readily see how the patient's hospital admission risk has changed over the recent past. Horizontal lines 546 may provide demarcations for moderate and high admission risk. Other layouts and arrangements are possible.

If desired, the horizontal axis 542 of the hospitalization risk timeline 540 may be adjustable by the user 100. Thus, the user 100 may view the hospital admission risk 340 further in the past for the patient and/or view the hospital admission risk 340 prospectively (i.e., in the future) for that patient.

The intervention summary 550 may have a plurality of rows 552, each of which may pertain to an intervention (and thus to one of the intervention reports 111). Thus, each of the rows 552 may have information similar to that of the intervention reports 111, as illustrated in FIG. 2A. Such information may optionally include the intervention date 200, the intervention type 210, the patient issues 220, and/or the follow-up items 230. The care provider ID 240 may not be shown in the row 552. The row 552 may illustrate interventions that were used in the calculation of the hospital admission risk 340 for the selected risk calculation date, which may be “Today” (Dec. 16, 2013).

The hospitalization risk timeline 540 may illustrate application of a stacking algorithm to provide the hospital admission risk 340 for each date. The change in hospital admission risk drops as the applicable time period 270 for an intervention expires, and rises as a new intervention occurs. If desired, the user 100 may have the option to mouse over and/or select a date to filter the intervention summary 550 for that date, provide the numerical value of the hospital admission risk 340 on that date, and/or view other information pertinent to that date.

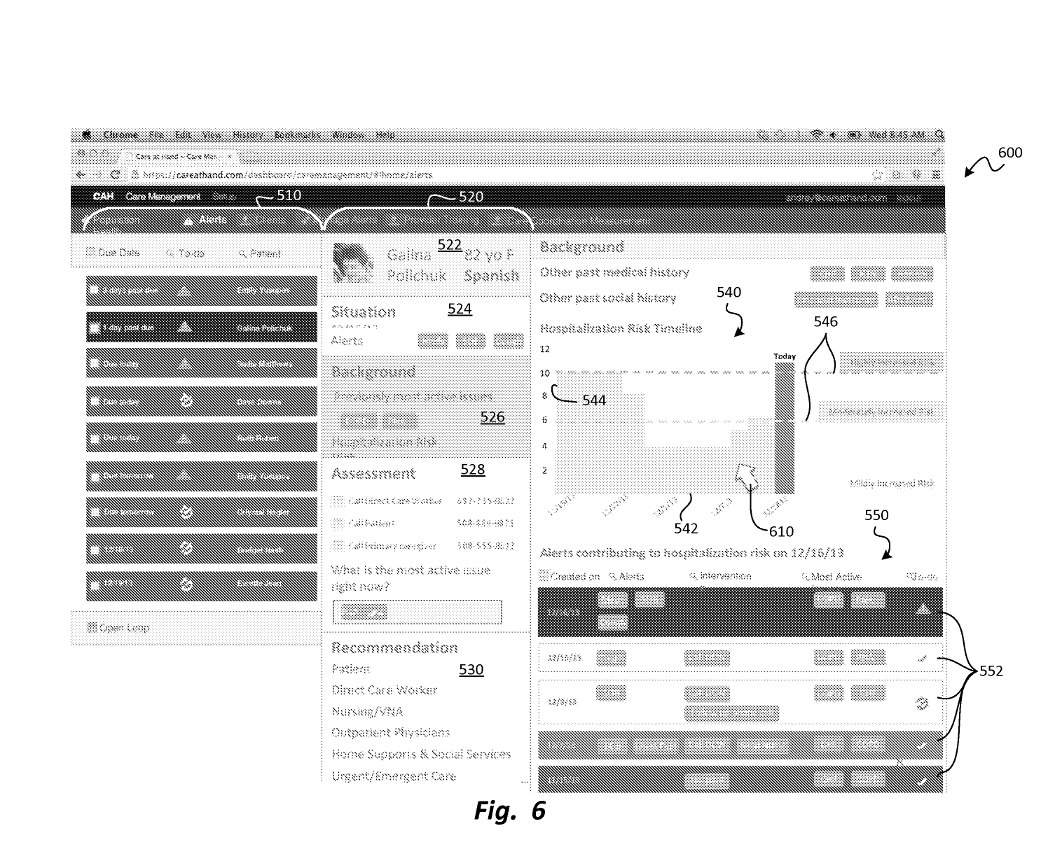

Referring to FIG. 6, a screenshot 600 illustrates the user interface with a pointer 610, which may be directed by the input device 102 of the device 101 and/or the client device 108. The pointer 610 may be poised to select a different risk calculation date from the hospitalization risk timeline 540. The user 100 may tap, click, or otherwise select the new date to update the intervention summary 550 to provide information regarding calculation of the hospital admission risk 340 for that risk calculation date.

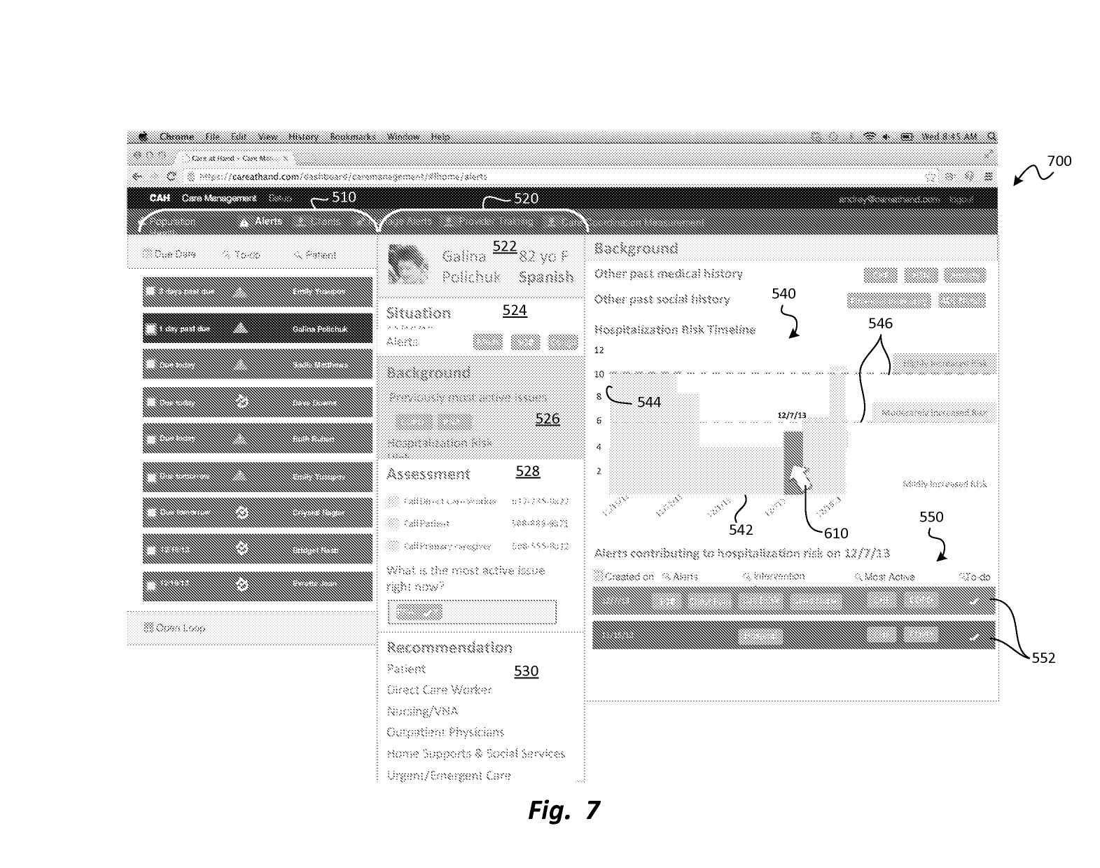

Referring to FIG. 7, a screenshot 700 illustrates the user interface with the pointer 610 after the user 100 has clicked or tapped to select the new risk calculation date. As shown, the intervention summary 550 has been updated to provide information regarding calculation of the hospital admission risk 340 for the newly selected risk calculation date (Dec. 7, 2013). There are fewer interventions that factored into the calculation of the hospital admission risk 340 as of the new risk calculation date, which has a lower hospital admission risk than the previously selected risk calculation date.

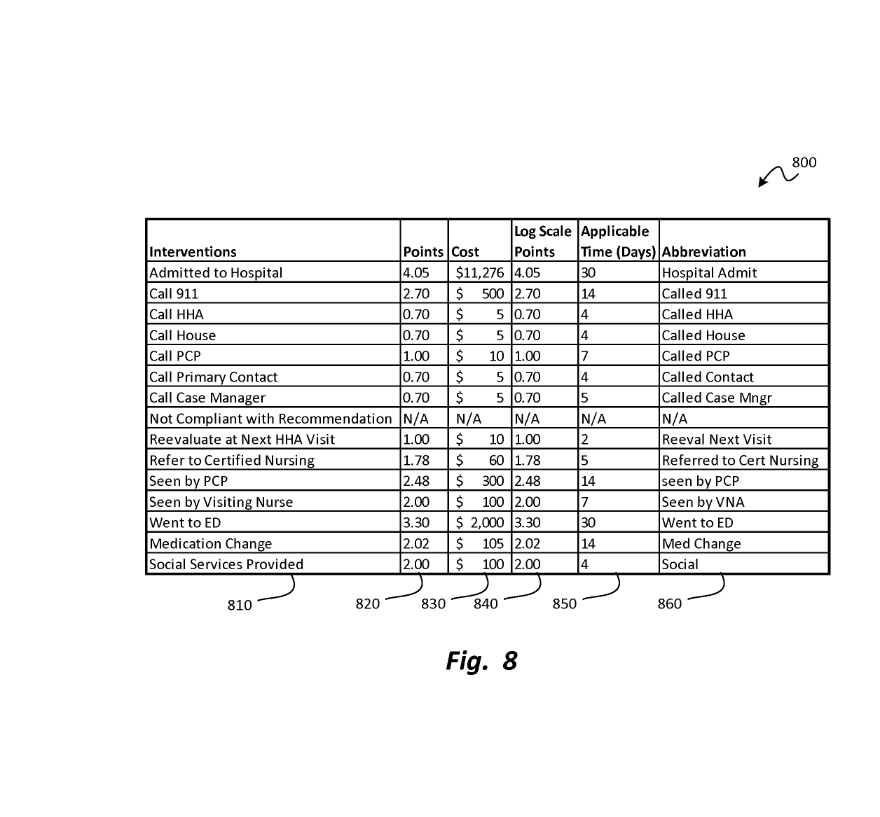

Referring to FIG. 8, a table 800 illustrates exemplary data structures related to the intervention score data 112. The table 800 may include data that is included in the intervention score data 112 of FIG. 2B. More specifically, the table 800 may have a first column 810, a second column 820, a third column 830, a fourth column 840, a fifth column 850, and a sixth column 860.

The first column 810 may include brief descriptions of various interventions. These may be intervention types 210, and may more specifically be treatment actions 214 as set forth in connection with FIG. 2A.

The second column 820 may include a number of points attributable to each corresponding intervention type 210. This may be the risk score 260, as set forth in connection with FIG. 2B.

The third column 830 may include the cost of each corresponding intervention type 210. This cost may optionally be included in the intervention score data 112, along with any other data that may facilitate determination of the hospital admission risk 340. This cost data may be used to obtain the point values of the second column 820. For example, the point values shown in the second column 820 are obtained by taking the logarithm of the costs in the third column 830.

The fourth column 840 may include the log scale points attributable to each corresponding intervention type 210. This may, in addition to or in the alternative to the point values of the second column 820, be included in the risk scores 260 of FIG. 2B.

The fifth column 850 may include the number of days over which each corresponding intervention type 210 is applicable. This may be the applicable time period 270 of FIG. 2B.

The sixth column 860 may include abbreviations applicable to each corresponding intervention type 210. These may be provided for easy user reference and/or to maintain consistency with how the intervention type 210 is referred to elsewhere. Such information may also optionally be included in the intervention score data 112, if desired.

FIG. 8 represents only one possible embodiment of data structures that may be used to provide the intervention score data 112. In other embodiments, the intervention score data 112 may have a wide variety of data structures different from that of the table 800.

The log transformation of interventions may be based on each intervention having a weight commensurate with at least one of: 1) the extent to which it is a proxy for clinical severity; and 2) the cost of intervention. Assigning a log algorithm to calculation of the risk score 260 used for each intervention may simplify calculation of the hospital admission risk 340 and allow for more meaningful clinical comparison to new risk factors and/or improvement after summation of the risk scores 260.

In at least one embodiment, the risk score 260 may be the logarithm of the cost of the intervention, wherein the cost of the intervention is based on the average cost of the intervention according got the most recent estimates of cost through public data and/or expert opinions. The types of interventions depicted in FIG. 8 are merely samples of the types of care coordination and care management interventions that may be documented through the use of the present disclosure.

Expert consensus and/or peer-reviewed literature may be used for establishing the applicable time periods 270, as shown in the example of FIG. 8. Heightened clinical suspicion may be visually represented via the horizontal lines 546 of FIGS. 5, 6, and 7.

For example, FIG. 7 shows a hospitalization on Nov. 15, 2013 in the intervention summary 550. The four-point height from Nov. 15, 2013 may perpetuate through Dec. 16, 2013. When the applicable time periods 270 for the interventions overlap with one another, the points for the interventions may “stack” and further heighten the hospital admission risk 340. FIGS. 7, 8, and 9 illustrate how the hospitalization risk timeline 540 is reflected below by the interventions contributing to hospital admission risk on the selected risk calculation day.

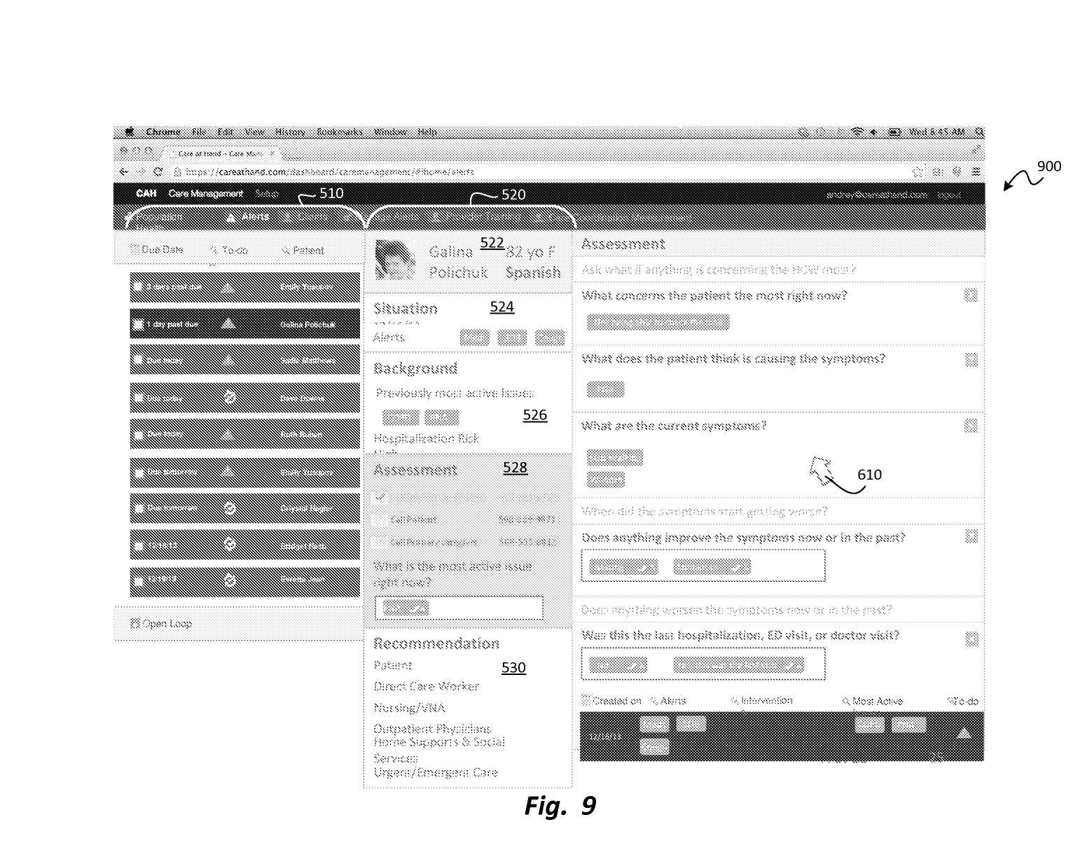

In at least one embodiment, the stacking algorithm may be updated once one or more current most active issues are selected. This will be further shown and described in connection with FIG. 9.

Referring to FIG. 9, a screenshot 900 illustrates the user interface after the user 100 has clicked or tapped on the patient assessment 528. Various queries may be presented to the user 100 to help the user 100 to identify one or more active issues. This identification may be used to determine which of the intervention types 210 should be recorded in the intervention report 111 for a given care episode. Further, if weights are used to weight interventions, as mentioned previously, the user's selection of which issue(s) are most active for the patient may help assign greater or lesser weights to the interventions provided.

One skilled in the art will recognize that the examples depicted and described herein are merely illustrative, and that other arrangements of user interface elements can be used. In addition, some of the depicted elements can be omitted or changed, and additional elements depicted, without departing from the essential characteristics.

The present system and method have been described in particular detail with respect to possible embodiments. Those of skill in the art will appreciate that the system and method may be practiced in other embodiments. First, the particular naming of the components, capitalization of terms, the attributes, data structures, or any other programming or structural aspect is not mandatory or significant, and the mechanisms and/or features may have different names, formats, or protocols. Further, the system may be implemented via a combination of hardware and software, or entirely in hardware elements, or entirely in software elements. Also, the particular division of functionality between the various system components described herein is merely exemplary, and not mandatory; functions performed by a single system component may instead be performed by multiple components, and functions performed by multiple components may instead be performed by a single component.

Reference in the specification to “one embodiment” or to “an embodiment” means that a particular feature, structure, or characteristic described in connection with the embodiments is included in at least one embodiment. The appearances of the phrases “in one embodiment” or “in at least one embodiment” in various places in the specification are not necessarily all referring to the same embodiment.

Various embodiments may include any number of systems and/or methods for performing the above-described techniques, either singly or in any combination. Another embodiment includes a computer program product comprising a non-transitory computer-readable storage medium and computer program code, encoded on the medium, for causing a processor in a computing device or other electronic device to perform the above-described techniques.

Some portions of the above are presented in terms of algorithms and symbolic representations of operations on data bits within a memory of a computing device. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “displaying” or “determining” or the like, refer to the action and processes of a computer system, or similar electronic computing module and/or device, that manipulates and transforms data represented as physical (electronic) quantities within the computer system memories or registers or other such information storage, transmission or display devices.

Certain aspects include process steps and instructions described herein in the form of an algorithm. It should be noted that the process steps and instructions can be embodied in software, firmware and/or hardware, and when embodied in software, can be downloaded to reside on and be operated from different platforms used by a variety of operating systems.

The present document also relates to an apparatus for performing the operations herein. This apparatus may be specially constructed for the required purposes, or it may comprise a general-purpose computing device selectively activated or reconfigured by a computer program stored in the computing device. Such a computer program may be stored in a computer readable storage medium, such as, but is not limited to, any type of disk including floppy disks, optical disks, CD-ROMs, DVD-ROMs, magnetic-optical disks, read-only memories (ROMs), random access memories (RAMs), EPROMs, EEPROMs, flash memory, solid state drives, magnetic or optical cards, application specific integrated circuits (ASICs), or any type of media suitable for storing electronic instructions, and each coupled to a computer system bus. Further, the computing devices referred to herein may include a single processor or may be architectures employing multiple processor designs for increased computing capability.

The algorithms and displays presented herein are not inherently related to any particular computing device, virtualized system, or other apparatus. Various general-purpose systems may also be used with programs in accordance with the teachings herein, or it may prove convenient to construct more specialized apparatus to perform the required method steps. The required structure for a variety of these systems will be apparent from the description provided herein. In addition, the system and method are not described with reference to any particular programming language. It will be appreciated that a variety of programming languages may be used to implement the teachings described herein, and any references above to specific languages are provided for disclosure of enablement and best mode.

Accordingly, various embodiments include software, hardware, and/or other elements for controlling a computer system, computing device, or other electronic device, or any combination or plurality thereof. Such an electronic device can include, for example, a processor, an input device (such as a keyboard, mouse, touchpad, track pad, joystick, trackball, microphone, and/or any combination thereof), an output device (such as a screen, speaker, and/or the like), memory, long-term storage (such as magnetic storage, optical storage, and/or the like), and/or network connectivity, according to techniques that are well known in the art. Such an electronic device may be portable or non-portable. Examples of electronic devices that may be used for implementing the described system and method include: a mobile phone, personal digital assistant, smartphone, kiosk, server computer, enterprise computing device, desktop computer, laptop computer, tablet computer, consumer electronic device, or the like. An electronic device may use any operating system such as, for example and without limitation: Linux; Microsoft Windows, available from Microsoft Corporation of Redmond, Wash.; Mac OS X, available from Apple Inc. of Cupertino, Calif.; iOS, available from Apple Inc. of Cupertino, Calif.; Android, available from Google, Inc. of Mountain View, Calif.; and/or any other operating system that is adapted for use on the device.

While a limited number of embodiments have been described herein, those skilled in the art, having benefit of the above description, will appreciate that other embodiments may be devised. In addition, it should be noted that the language used in the specification has been principally selected for readability and instructional purposes, and may not have been selected to delineate or circumscribe the subject matter. Accordingly, the disclosure is intended to be illustrative, but not limiting, of scope.

What is claimed is:

1. A computer-implemented method for evaluating hospital admission risk of a patient on a first risk calculation date, the method comprising:
at an input device, receiving first user input indicative of a first intervention performed for the patient;
from a data store, retrieving a first risk factor corresponding to the first intervention;
from the data store, retrieving a first time period over which the first risk factor is applicable;
at a processor, comparing a first intervention date of the first intervention with the first risk calculation date to determine that the first risk calculation date is within the first time period;
at the processor, using the first risk factor to compute the hospital admission risk for the patient; and
at an output device, outputting the hospital admission risk.

2. The method of claim 1, further comprising:
at the input device, receiving second user input indicative of a second intervention performed for the patient;
from the data store, retrieving a second risk factor corresponding to the second intervention;
and wherein computing the hospital admission risk for the patient further comprises using the second risk factor.

3. The method of claim 2, further comprising:
from the data store, retrieving a second time period over which the second risk factor is applicable; and
at the processor, comparing a second intervention date of the second intervention with the first risk calculation date to determine that the first risk calculation date is within the second time period.

4. The method of claim 3, further comprising:
at the output device, outputting intervention data for each of a first plurality of interventions with risk factors applicable on the first risk calculation date;
wherein outputting the intervention data comprises outputting a first intervention type of the first intervention, a first intervention date of the first intervention, a second intervention type of the second intervention, and a second intervention date of the second intervention.

5. The method of claim 4, further comprising:
at the input device, receiving third user input selecting the first risk calculation date from among a plurality of dates;
wherein outputting the intervention data is performed responsive to receipt of the third user input.

6. The method of claim 5, further comprising:
at the input device, receiving fourth user input selecting a second risk calculation date from among the plurality of dates; and
at the output device, responsive to receipt of the fourth user input, outputting intervention data for each of a second plurality of interventions with risk factors applicable on the second risk calculation date.

7. The method of claim 3, wherein the first risk factor comprises a first risk score and the second risk factor comprises a second risk score;
and wherein computing the hospital admission risk comprises computing a log transformation of the first risk score and the second risk score.

8. The method of claim 7, wherein computing the hospital admission risk further comprises adding a change factor to the log transformation;
wherein the change factor is obtained by comparing risk scores applicable to all interventions for the patient within a recent time period, with an average of risk scores applicable to all interventions for the patient over a reference time period.

9. The method of claim 7, wherein computing the hospital admission risk further comprises adding a change factor to the log transformation;
wherein the change factor is obtained by adding risk scores applicable to all interventions provided during a single care episode for the patient.

10. The method of claim 7, wherein computing the hospital admission risk further comprises adding a first change factor and a second change factor to the log transformation;
wherein the first change factor is obtained by comparing risk scores applicable to all interventions for the patient within a recent time period, with an average of risk scores applicable to all interventions for the patient over a reference time period;
wherein the second change factor is obtained by adding risk scores applicable to all interventions provided during a single care episode for the patient.

11. The method of claim 1, wherein the first intervention comprises a first intervention type that can readily be provided without bringing the patient to a hospital.

12. The method of claim 1, wherein the first risk factor comprises a first risk score with a magnitude based on a level of clinical severity of an intervention type of the first intervention.

13. The method of claim 1, wherein the first risk factor comprises a first risk score with a magnitude based on an estimated cost of providing the first intervention.

14. The method of claim 13, wherein the first risk score is a logarithm of the estimated cost.

15. A computer program product for evaluating hospital admission risk of a patient on a first risk calculation date, the computer program product comprising:
a non-transitory storage medium; and
computer program code, encoded on the medium, configured to cause at least one processor to perform the steps of:
causing an input device to receive first user input indicative of a first intervention performed for the patient;
from a data store, retrieving a first risk factor corresponding to the first intervention;
from the data store, retrieving a first time period over which the first risk factor is applicable;
comparing a first intervention date of the first intervention with the first risk calculation date to determine that the first risk calculation date is within the first time period;
using the first risk factor to compute the hospital admission risk for the patient; and
causing an output device to output the hospital admission risk.

16. The computer program product of claim 15, wherein the computer program code is further configured to cause the at least one processor to perform the steps of:
causing the input device to receive second user input indicative of a second intervention performed for the patient;
from the data store, retrieving a second risk factor corresponding to the second intervention;
and wherein the computer program code configured to cause the at least one processor to compute the hospital admission risk for the patient further comprises computer program code configured to cause the at least one processor to use the second risk factor.

17. The computer program product of claim 16, wherein the computer program code is further configured to cause the at least one processor to perform the steps of:
from the data store, retrieving a second time period over which the second risk factor is applicable; and
comparing a second intervention date of the second intervention with the first risk calculation date to determine that the first risk calculation date is within the second time period.

18. The computer program product of claim 17, wherein the computer program code is further configured to cause the at least one processor to perform the step of:
causing the output device to output intervention data for each of a first plurality of interventions with risk factors applicable on the first risk calculation date;
wherein the computer program code configured to cause the at least one processor to cause the output device to output the intervention data comprises compute program code configured to cause the at least one processor to cause the output device to output a first intervention type of the first intervention, a first intervention date of the first intervention, a second intervention type of the second intervention, and a second intervention date of the second intervention.

19. The computer program product of claim 18, wherein the computer program code is further configured to cause the at least one processor to perform the step of:
causing the input device to receive third user input selecting the first risk calculation date from among a plurality of dates;
wherein the computer program code configured to cause the at least one processor to cause the output device to output the intervention data comprises computer program code configured to cause the at least one processor, responsive to receipt of the third user input, to cause the output device to output the intervention data.

20. The computer program product of claim 19, wherein the computer program code is further configured to cause the at least one processor to perform the steps of:
causing the input device to receive fourth user input selecting a second risk calculation date from among the plurality of dates; and
responsive to receipt of the fourth user input, causing the output device to output intervention data for each of a second plurality of interventions with risk factors applicable on the second risk calculation date.

21. The computer program product of claim 17, wherein the first risk factor comprises a first risk score and the second risk factor comprises a second risk score;
and wherein the computer program code configured to cause the at least one processor to compute the hospital admission risk comprises computer program code configured to cause the at least one processor to compute a log transformation of the first risk score and the second risk score.

22. The computer program product of claim 21, wherein the computer program code configured to cause the at least one processor to compute the hospital admission risk comprises computer program code configured to cause the at least one processor to add a change factor to the log transformation;
wherein the change factor comprises at least one selection from the group consisting of:
a first change factor obtained by comparing risk scores applicable to all interventions for the patient within a recent time period, with an average of risk scores applicable to all interventions for the patient over a reference time period; and
a second change factor obtained by adding risk scores applicable to all interventions provided during a single care episode for the patient.

23. The computer program product of claim 15, wherein the first intervention comprises a first intervention type that can readily be provided without bringing the patient to a hospital.

24. The computer program product of claim 15, wherein the first risk factor comprises a first risk score with a magnitude based on at least one selection from the group consisting of:
a level of clinical severity of an intervention type of the first intervention; and
an estimated cost of providing the first intervention.

25. A system for evaluating hospital admission risk of a patient on a first risk calculation date, the system comprising:
an input device, configured to:
receive first user input indicative of a first intervention performed for the patient;
a data store, configured to:
retrieve a first risk factor corresponding to the first intervention; and
retrieve a first time period over which the first risk factor is applicable;
a processor, communicatively coupled to the input device and the data store, configured to:
compare a first intervention date of the first intervention with the first risk calculation date to determine that the first risk calculation date is within the first time period; and
use the first risk factor to compute the hospital admission risk for the patient; and
an output device, communicatively coupled to the processor, configured to:
output the hospital admission risk.

26. The system of claim 25, wherein the input device is further configured to:
receive second user input indicative of a second intervention performed for the patient;
wherein the data store is further configured to:
retrieve a second risk factor corresponding to the second intervention;
and wherein the processor is further configured to compute the hospital admission risk for the patient by using the second risk factor.

27. The system of claim 26, wherein the data store is further configured to:
retrieve a second time period over which the second risk factor is applicable;
wherein the processor is further configured to:
compare a second intervention date of the second intervention with the first risk calculation date to determine that the first risk calculation date is within the second time period.

28. The system of claim 27, wherein the output device is further configured to:
output intervention data for each of a first plurality of interventions with risk factors applicable on the first risk calculation date;
wherein the output device is further configured to output the intervention data by outputting a first intervention type of the first intervention, a first intervention date of the first intervention, a second intervention type of the second intervention, and a second intervention date of the second intervention.

29. The system of claim 28, wherein the input device is further configured to:
receive third user input selecting the first risk calculation date from among a plurality of dates;
wherein the output device is further configured to output the intervention data responsive to receipt of the third user input.

30. The system of claim 29, wherein the input device is further configured to:
receive fourth user input selecting a second risk calculation date from among the plurality of dates;
wherein the output device is further configured, responsive to receipt of the fourth user input, to:
output intervention data for each of a second plurality of interventions with risk factors applicable on the second risk calculation date.

31. The system of claim 27, wherein the first risk factor comprises a first risk score and the second risk factor comprises a second risk score;
and wherein the processor is further configured to compute the hospital admission risk by computing a log transformation of the first risk score and the second risk score.

32. The system of claim 31, wherein the processor is further configured to compute the hospital admission risk by adding a change factor to the log transformation;
wherein the processor is further configured to obtain the change factor by performing at least one step selected from the group consisting of:
comparing risk scores applicable to all interventions for the patient within a recent time period, with an average of risk scores applicable to all interventions for the patient over a reference time period; and
adding risk scores applicable to all interventions provided during a single care episode for the patient.

33. The system of claim 25, wherein the first intervention comprises a first intervention type that can readily be provided without bringing the patient to a hospital.

34. The system of claim 25, wherein the first risk factor comprises a first risk score with a magnitude based on at least one selection from the group consisting of:
a level of clinical severity of an intervention type of the first intervention; and
an estimated cost of providing the first intervention.
